(19) United States
(12) Patent Application Publication
(10) Pub. No.: US 2011/0219626 A1
(43) Pub. Date: Sep. 15, 2011

(54) DRILL ATTACHMENT

(75) Inventors: Thilo Broeker, Detmold (DE); Christoph Dierks, Detmold (DE)

(73) Assignee: WEIDMUELLER INTERFACE GMBH & CO. KG, Detmold (DE)

(21) Appl. No.: 13/061,152

(22) PCT Filed: Aug. 25, 2009
(86) PCT No.: PCT/EP2009/060911

§ 371 Date: May 11, 2011

(30) Foreign Application Priority Data
Sep. 18, 2008 (DE) 20-2008 012 415.8

(51) Int. Cl. B23D 29/00; B23D 17/04

(52) U.S. Cl. 30/92; 30/249

(57) ABSTRACT

A drill cutting attachment for severing an electrical conductor includes a housing, a stationary cutting blade connected with the housing, a movable cutting blade pivotally connected with the stationary cutting blade for displacement about a given cutting pivot axis between open and closed positions relative to the stationary cutting blade, and a pawl and ratchet arrangement for displacing the movable cutting blade from the open position toward the closed position, thereby to sever an electrical conductor positioned between the blades. The pawl and ratchet arrangement includes a transport pawl member that is longitudinally reciprocated by a rotary drive shaft via either an eccentric and crank arm drive arrangement, or a cam and follower drive arrangement. The drive shaft has a free end with a hexagonal cross-sectional configuration for connection with the chuck of an electric drill, and an attachment sleeve connects the housing with the electric drill body.

### REFERENCE TO RELATED APPLICATIONS

This application is a continuation of the International Application No. WO 2010/031658 which is based on the PCT Application PCT/EP2009/060911 filed Aug. 25, 2009, claiming priority of the German application No. DE 20 2008 012 415.8, filed Sep. 18, 2008.

### BACKGROUND OF THE INVENTION

1. Field of the Invention

A drill cutting attachment for severing an electrical conductor includes a housing, a stationary cutting blade connected with the housing, a movable cutting blade pivotally connected with the stationary cutting blade for displacement about a given cutting pivot axis between open and closed positions relative to said stationary cutting blade, and a pawl and ratchet arrangement driven by a drive shaft for displacing the movable cutting blade from the open position toward the closed position, thereby to sever an electrical conductor positioned between the blades.

2. Description of Related Art

A typical drilling machine head piece is known from the European patent No. EP 1525958 A1. The drilling machine head piece is so designed that it has a housing, a first and a second cutting unit, which move with relation to each other, as well as at least one drive unit driving the cutting units with a drive shaft that is rotatably positioned around its longitudinal axis, which protrudes out of the housing in order to be clamped into the drill chuck of a drilling machine. In this case, the drive unit consists of a worm gear pair, whereby the endless screw is mounted on the drive shaft and rotates with the drive shaft on a first arbor. The worm gear pair is mounted on a worm gear arbor that drives a drive unit which, during operation, engages at least one of the cutting units in order to move this one blade with relation to the other blade. At least one of the cutting units has on an outer side a tooth segment in which engages the drive unit. Furthermore, this drilling machine head piece has a torque arm that on one end is attached upon the housing and that on the other end is attached to the handle of the drilling machine in order to prevent a relative rotation of the housing with respect to the drilling machine.

There is one disadvantage that is connected with the typical drilling machine head piece—namely, the high structural effort and the comparatively heavy weight of the drilling machine head piece as a result of the worm gear pair. Besides, in case of any possibly occurring clamping of the cutting units and a cable clamped in between, the clamping of the drilling machine head piece can be released only by switching the drilling machine into the opposite direction of rotation. Under certain circumstances, the worm gear pair and/or the tooth segment could be damaged on the cutting unit.

### SUMMARY OF THE INVENTION

Accordingly, a primary object of the invention is to provide a cutting apparatus for severing an electrical conductor includes a housing, a stationary cutting blade connected with the housing, a movable cutting blade pivotally connected with the stationary cutting blade for displacement about a given cutting pivot axis between open and closed positions relative to said stationary cutting blade, and a pawl and ratchet arrangement for displacing the movable cutting blade from the open position toward the closed position, thereby to sever an electrical conductor positioned between the blades.

According to a more specific object, the pawl and ratchet arrangement includes a transport pawl member that is longitudinally reciprocated by a rotary drive shaft via either an eccentric and crank arm drive arrangement, or a cam and follower drive arrangement.

According to a further object, the drive shaft has a free end with a hexagonal cross-sectional configuration for connection with the chuck of an electric drill that operates the conductor cutting apparatus, and an attachment sleeve connects the housing of the cutting apparatus with the electric drill body.

A further object is to provide a drive system including a locking pawl that retains the movable pawl against return displacement during the reciprocatory displacement of the transport pawl member. The locking pawl may be displaced to an inoperable position by locking pawl disconnect means.

In the drill-driven cutting apparatus of the present invention, the rotary movement of the drive shaft is converted into a translation movement of a transport ratchet member, which moves alternately along a longitudinal shifting axis, and in the process drives at least one of the cutting blade units.

By using a crank drive for the conversion of the rotary movement of the drive shaft into a translation movement of the transport ratchet member, one can bring about the advancement of at least one of the cutting blades by means of a simple and trouble-free mechanical arrangement.

In alternative embodiments, a disc cam drive is used for the conversion of the rotary movement into a translation movement. In a particularly preferred manner, a free-wheel is arranged is provided between a disc cam and a cam roller, whereby the transport ratchet member is driven only in one running direction of the drive shaft.

The rotatable arrangement of the transport ratchet on a sliding block driven by the crank drive or the disc cam drive makes it possible to make sure that the transport ratchet will always be safely engaged with the ratchet teeth of the driven cutting unit.

The sickle-shaped arrangement of the movable cutting blade with an internal cutting edge and an external ratchet tooth arrangement facilitates a reliable force transfer from the transport pawl member to the movable cutting unit.

To prevent an unintended movement of the movable cutting blade against a push direction of the transport pawl member, the drive means further includes a locking pawl that keeps the movable cutting blade in that position after an advancement.

The arrangement of a resilient return member between the locking ratchet and the transport pawl member' ensures a simple mechanical restoration of transport and locking ratchet into an initial starting position.

It is furthermore advantageous that the return member simultaneously biases the transport pawl member against the ratchet teeth of the movable cutting blade.

By the arrangement of a suitable biasing arrangement, the locking pawl is also reliably pressed against the ratchet teeth of the movable cutting blade.

The alignment of the ratchet teeth on the movable cutting blade is such that a force, exerted by the transport pawl member upon the ratchet teeth, can be applied only in the cutting direction of the second cutting unit; therefore, it facilitates a slippage of the transport ratchet during the return run over the back of the tooth to the next tooth of the ratchet teeth arrangement.

By making a lever on the housing that is positioned rotatably on that housing and upon the first cutting unit eccentrically on a second pivot axis, one can, by means of this lever, shift the entire cutting unit with respect to the housing in such a way that the ratchet teeth of the movable cutting blade can be so adjusted that they will no longer engage the drive unit. This facilitates a simple interruption of a cutting process in case of a mistaken cut, an arrangement that moreover is easier on the ratchet teeth.

A supporting sleeve, arranged on the head piece in a position axially with respect to the drive shaft, ensures a secure torque support of the cutting attachment with respect to the drilling machine that drives the cutting attachment.

### BRIEF DESCRIPTION OF THE DRAWINGS

Other objects and advantages of the invention will become apparent from a study of the following specification, when viewed in the light of the accompanying drawing, in which:

FIGS. 1 and 2 are right-hand and left-hand elevation views, respectively, of the drill attachment cutting apparatus of the present invention;

FIG. 3 is a detailed perspective view of a crank drive arrangement for driving the cutting means of the apparatus of FIG. 1, with certain parts removed for clarity;

FIG. 4 is a detailed perspective view of a cam drive arrangement for driving the cutting means of FIG. 1, with certain parts removed for clarity;

FIGS. 5-7 are perspective views illustrating the steps for progressively disengaging the locking pawl from the ratchet teeth; and

FIGS. 8-11 are detained side elevation views illustrating the cooperation between the transport pawl member and the locking pawl for pivotally displacing the movable cutting blade in the cutting direction.

### DETAILED DESCRIPTION OF THE INVENTION

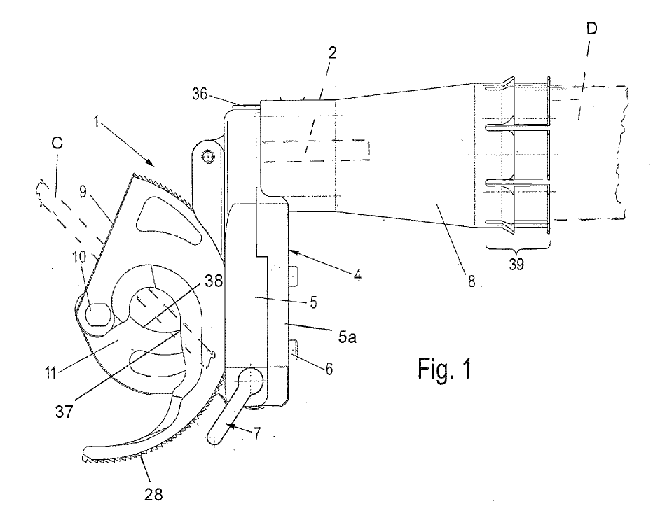

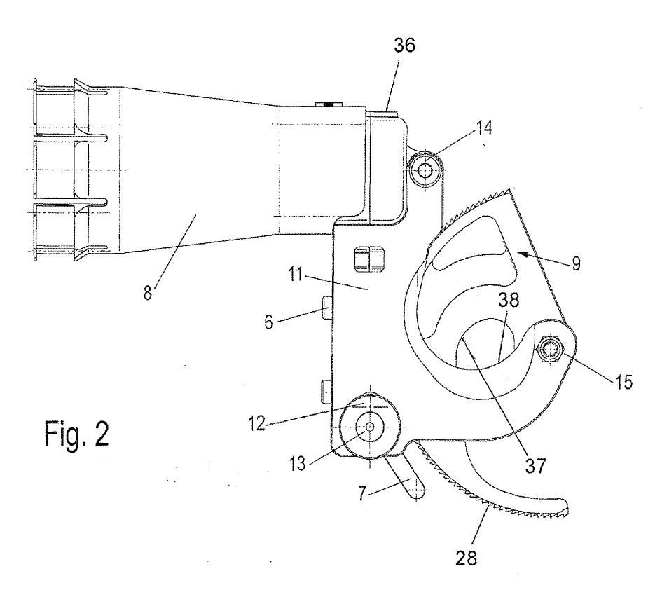

Referring first more particularly to FIGS. 1 and 2, the drill cutting attachment 1 of the present invention includes a sectional housing 4 including a body section 5 to which a removable cover section 5a is fastened by a plurality of bolts 6. Connected at one end with one end of the housing 4 by means of a cover cap 36 is a supporting sleeve 8. At its other end, the supporting sleeve 8 has an annular expansible resilient finger portion 39 adapted for removable connection with the operating end body portion of a hand-held electric drill D.

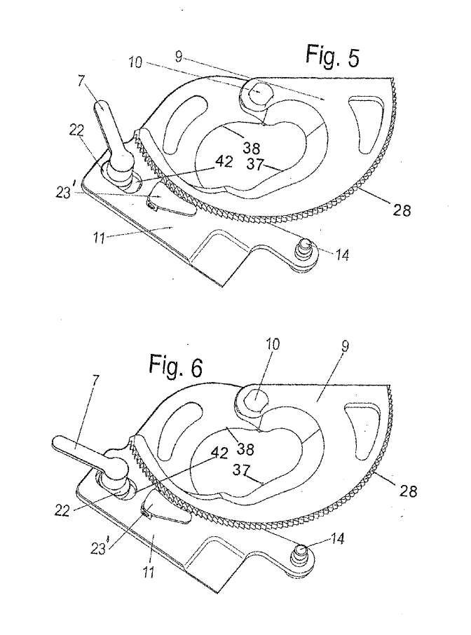

Pivotally connected with the housing 4 by pivot means 14 defining a disconnect pivot axis is a stationary cutting blade 11 having an sickle-shaped internal cutting edge 37. Pivotally connected by bolt 10 and lock nut 15 (FIG. 2) with the stationary cutting blade 11 for pivotal movement about a cutting pivot axis is the movable cutting blade 9 which also has a corresponding reversely-arranged sickle-shaped internal cutting edge 37. The outer circumferential surface of the movable cutting blade 9 is provided with a ratchet tooth arrangement 28 having a generally circular arcuate pattern relative to the cutting pivot axis defined by the bolt 10. As will be described in greater detail below, a disconnect lever 7, having a shaft 13 with an annular stop 12 is connected for pivotal movement relative to the housing 4, operates eccentric means 22 (FIGS. 5-7) for adjusting the stationary cutting blade 11 between engaged and disengaged positions relative to the housing 4.

Both cutting units 9, 11 are preferably made sickle-shaped with interior cutting edges 37, 38. If the movable cutting blade 9 is pivoted toward the first cutting unit 11, then the opening between the two cutting edges 37, 38 will be narrowed so that a conductor or cable C introduced into this opening will be cut as the opening is completely closed. At least the movable cutting blade 9 furthermore on its outer edge has a ratchet tooth arrangement 28 with ratchet teeth 29 that are preferably lined up at equal intervals.

To support the torque of the drilling machine cutting attachment relative to the drilling machine D, there is arranged coaxially about the drive shaft 2 a supporting sleeve 8. Connecting tab 36 connects one end of the supporting sleeve 8 to the housing 4, and the other end of the sleeve includes a resilient finger clamping arrangement 39 for the purpose of firmly clamping the supporting sleeve 8 to the body of the electric drill D. When the drilling machine cutting attachment 1 is attached to a drilling machine D, the supporting sleeve 8, together with the attachment 1, is pushed over a drill chuck of the drilling machine and is preferably firmly clamped and secured on the drilling machine with a friction clip (not shown) that presses the clamping part 39 together. In a special embodiment, a drive sleeve (not shown) is first of all chucked into the drill chuck of the drilling machine. Into this drive sleeve, as the supporting sleeve 8 and the drilling machine attachment 1 are slid over the drill chuck of the drilling machine, the drive shaft 2 of the attachment 1 is inserted so that in this manner a rotary movement can be transmitted from the drilling machine to the drive shaft 2.

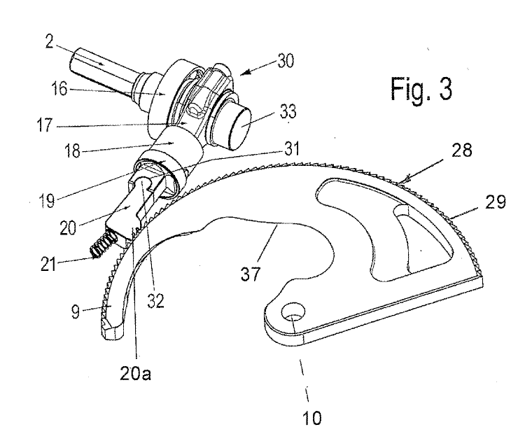

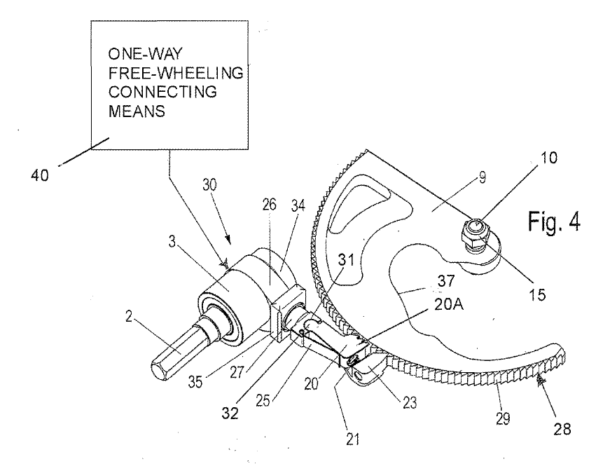

For the translation of the rotary drive moment from drive shaft 2, which is clamped into the drilling machine drill chuck, to the transport pawl member 20, one of two types of drive mechanisms may be provided: namely, the eccentric and crank arm drive arrangement 30 of FIG. 3, or the cam disc and cam follower drive arrangement 30′ of FIG. 4.

Referring now to FIG. 3, the rotatably-driven drive shaft 2 is supported by bearings means 16 for rotation within an opening contained in the housing 4, a first end of the drive shaft being connected with eccentric crank arm drive means 30 for reciprocating a transport pawl member 20. The other end of the drive shaft has a hexagonal cross-sectional configuration for direct or indirect connection with the chuck means of the hand drill 2. The drive means 30 includes an eccentric cylindrical member 33 that is connected with said drive shaft first end, the eccentric cylindrical member having a longitudinal axis that is parallel with, and laterally offset from, the longitudinal axis of the drive shaft 2. A connecting rod or crank arm 17 contains at one end an opening in which is journalled the eccentric cylindrical member 33. The other end of the crank arm is connected with a cylindrical sliding block 18 that is supported for longitudinal axial displacement relative to the housing 4 by a protective annular member 19. For protection against the soiling of the crank drive, the protective ring 19, which is preferably made as a felt ring, is attached in housing 4.

A transport pawl member 20 is pivotally connected at one end with the adjacent end of the sliding block 18 by pivot means including a rounded knob end portion 32 that extends within a corresponding rounded recess 31 contained in adjacent end of the sliding block 18. This transport pawl pivot axis is parallel with the cutting pivot axis defined by the pivot pin 10 of FIG. 1. At its other end, the transport pawl member include a plurality of pawl teeth 20a that are arranged for engagement with the ratchet tooth arrangement 28 on the movable cutting blade 9. Spring means 21 bias the transport pawl member in a direction to effect engagement between the transport pawl teeth 20a and the ratchet teeth 28.

When the drive shaft 2 is rotatably driven by the electric hand drill D, the crank arm connecting rod 17, the sliding block 18, and the transport pawl member 20 are axially reciprocated by the eccentric cylinder upon which the crank arm is journalled. When the transport pawl member travels in one direction, the pawl teeth 20a cooperate with the ratchet teeth 28 to incrementally displace the movable cutting blade 9 in the cutting direction. On the return stroke, the inclined surfaces of the ratchet teeth cause disengagement of the transport pawl teeth 20a, whereby upon the next drive stroke, the transport teeth are again biased by spring 21 toward engagement with the ratchet teeth. The spring 21 supports the force-controlled return of transport pawl member 20 and at the same time provides a press-on moment for the transport pawl member 20 against the movable cutting blade 9.

When one uses a crank drive (FIG. 3), the drilling machine D transfers the drive moment, for example, via a triple-cheek drill chuck to the drive shaft 2. Drive shaft 2 is positioned on a ball bearing in housing 4, preferably a double ball bearing. Between the bearings on drive shaft 2, there is a lifting cylinder 33 that is offset eccentrically. By means of this crank drive, the drive moment is converted via a connecting rod 17 into a translation movement of a preferably round sliding block 18.

Referring now to FIG. 4, in this alternate embodiment the drive means 30′ for reciprocating the transport pawl member 20 is of the cam disk and follower type, with the drive shaft 2 being supported by ball bearing means 3 for rotation within an opening contained in the wall of the housing 4. The drive shaft 2 is connected at one end via one-way free-wheeling connecting means 40 with a cam support cylinder 34 upon which is concentrically secured an annular cam disk 26. The cam disk includes an eccentric cam circumferential surface relative to the longitudinal axes of the drive shaft 2 and the cam support roller 34. The cam follower comprises a sliding block 27 having an end surface that is biased toward engagement with the circumferential cam surface of the cam disk 26. The sliding block 27 is supported intermediate its ends for axial longitudinal displacement relative to the housing 4 by a fixed dirt scraper 35.

Transport pawl member 20 is pivotally connected at one end with the other end of the sliding block 27 by pivot means comprising the pivot knob 32 at one end of the transport pawl member, and a corresponding recess 31 contained in the adjacent end of the sliding block 27. This pivot axis of the transport pawl member is parallel with the cutting pivot axis of movable cutting blade 9 as defined by the bolt 10. In this embodiment, the transport pawl member is biased by leaf spring 25 to effect engagement of pawl teeth 20a with the ratchet tooth arrangement 28 on the movable cutting blade 9. As will be described in greater detain below, during the reciprocatory motion of the transport pawl member 20, a locking pawl 23 mounted on the stationary cutting blade 11 cooperates with the pawl teeth 20a of transport pawl member 20 to incrementally pivot the cutting blade 9 in the cutting direction.

Here again, the electric hand drill D transmits the drive moment to the drive shaft 2 via the drilling machine drill chuck. Drive shaft 2 is preferably made here as a hexagon that can be clamped into the triple-cheek lining of a drilling machine. Drive shaft 2 is supported by ball bearing means 3 in housing 4, preferably on a double ball bearing, and transmits the torque to the cam support cylinder 34 via the one-way free-wheeling connecting means. Arranged on this cam roller 34 is a cam disc 26 that rotates with the cam roller. The sliding block 27, similar to the already mentioned sliding block 18 in connection with the previous crank drive embodiment, which in this case works along the functional principle of a cam follower device, moves in a sliding manner over the outer circumferential surface of cam disc 26. In this way, the rotary movement of the drive shaft 2 and the cam disc 26 is transformed into an alternating translation movement. Sliding block 18 is cylindrical, together with a dirt scraper 35, prevents the cam disc means from becoming soiled.

In this embodiment, conventional one-way free-wheeling clutch or connecting means accepts the rotary moment at a specific direction of rotation from the drive shaft 2 and passes it on to a cam roller 34. The free-wheel here is preferably made as a sleeve free-wheel device, although a sliding clutch would also be conceivable here. In this manner, in case of an inappropriate direction of rotation of drive shaft 2, the drive moment is not picked up because such a direction of rotation, due to the altered movement course of the cam roller 34, can result in the destruction of teeth 29 on the second cutting unit 9 and the transport pawl member 20.

As described earlier, transport pawl member 20 is pivotally connected with the sliding block 27 and pushes, preferably with each drive shaft rotation, the movable cutting blade 9 forward by one ratchet tooth 29. Here again, a compression biasing spring 21 provides the biasing pressure of sliding block 27 upon the circumferential surface of cam disc 26, and during the return lift, pushes transport pawl member 20 back together with the sliding block 27 toward the cam disk 26. An accompanying biasing spring 25, which is preferably made as a leaf spring on sliding block 27, provides the biasing force of the transport pawl member 20 against the movable cutting blade 9.

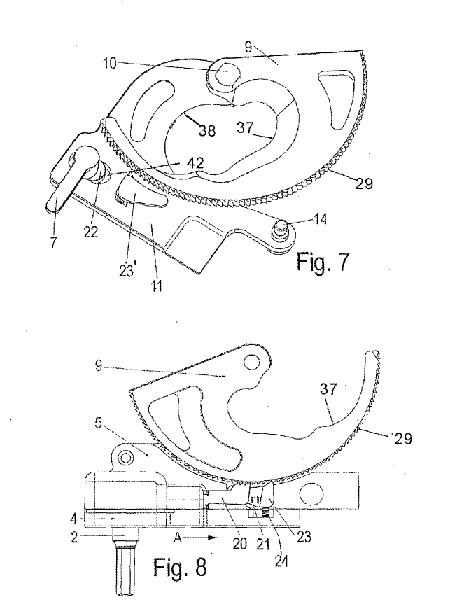

Referring now to the modification of FIGS. 5-7, the locking pawl 23′ is fastened to the stationary cutting blade 11, which in turn is pivotally connected by pivot pin 14 for slight angular adjustment relative to the housing 4, as shown in FIGS. 1 and 2. Mounted on the shaft 13 of the disconnect lever 7 is an eccentric member 22 that is received in the slot 42 contained in the stationary cutting blade 11. When the lever 7 and the eccentric member 22 are in the initial engaged position of FIG. 5, the locking pawl 23′ is in engagement with the ratchet tooth arrangement 28 on movable cutting blade 9. As the lever 7 is pivoted through the intermediated position of FIG. 6 toward the fully disengaged position of FIG. 7, the stationary blade 11 is progressively pivoted relative to the housing 4 to progressively displace the locking pawl 23′ away from the cutting blade 9, thereby to disengage the locking pawl 23′ completely from the ratchet tooth arrangement 28 on cutting blade 9.

The stationary cutting blade 11 is pivotally connected with the housing 4, and the movable cutting blade 9 is pivotally connected with the stationary cutting blade 11. Consequently. both cutting blades 9, 11 are displaced by lever 7 in one pivotal direction to effect disengagement of the transport pawl teeth 20a and locking pawl 23′ from the ratchet tooth arrangement 28. Due to this common movement, there is, as result, no further cutting action. Besides, during this movement, transport pawl 20 and locking pawl 23′ are not stressed. Only when the movable cutting blade 9 is disengaged from transport pawl teeth 20a and locking pawl 23′ can the cutting blade 9 be displaced in the opposite direction for the purpose of releasing a conductor or cable C.

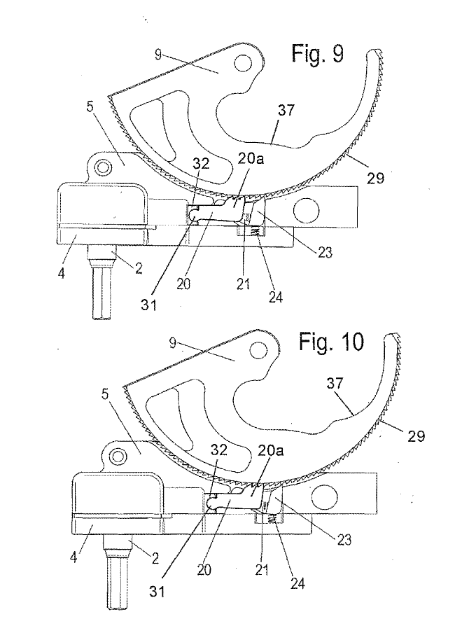

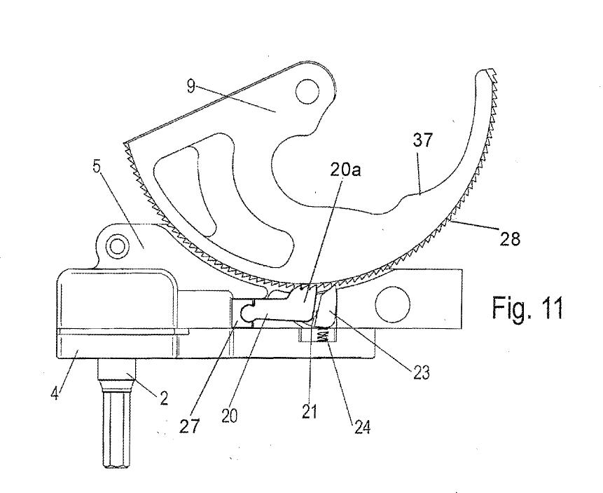

FIGS. 8-11 illustrate the cooperation between the transport pawl member 20 and the locking pawl 23 in incrementally pivoting the movable cutting blade in the cutting direction. By actuating the drive unit 30, sliding block 27 is made to form an alternating translation movement. This movement of sliding block 27 is passed on to transport pawl member 20. Transport pawl member 20 is preferably pivotally connected with sliding block 27. For this purpose, there is provided on the side of sliding block 27 facing toward transport pawl member 20 a pan-like recess 31 in sliding block 27, and on the end facing toward sliding block 27, transport pawl member 20 has a rounded knob projection 32 that fits into the pan-like recess 31. This in a simple fashion makes it possible for transport pawl member 20 to follow the curved outside circumferential surface of cutting blade 9. Transport pawl member 20, first of all, transports the movable cutting blade 9 in each case by one ratchet tooth 29, and besides, a part of this pushing work is stored in a return spring 21, which is arranged between transport pawl member 20 and a locking pawl 23 that is opposite the transport pawl member 20. The energy stored in return spring 21 is subsequently needed for biasing the transport pawl member 20 toward the retreating sliding block 27. The return member 21 is preferably made as a compression spring.

Return spring 21 is furthermore so arranged that, along with the storage of the work for the biasing pressure upon sliding block 27, it also provides the biasing force of the transport pawl member 20 toward the movable cutting blade 9. A second spring element 24 is biases the locking pawl 23 against the movable second cutting blade 9.

In FIGS. 8 to 11, one can easily see that ratchet teeth 29 of the arrangement 28 are so shaped that a force can be introduced only in the cutting direction, and upon the return motion, the locking pawl 23 will hold the second cutting unit 9 in position, while the transport pawl 20 will slide off to the next tooth 29 over the back of the tooth. The same thing happens in the case of locking pawl 23 during the forward motion. Here, transport pawl member 20 transports the movable cutting blade 9 further, while locking pawl 23 slides off to the next tooth 29 over the back of the tooth. Preferably, upon each drive shaft rotation, the movable cutting blade 9 is further transported by one tooth 29. An alternating advance motion is generated because both movements take place alternately after each other.

While in accordance with the provisions of the Patent Statutes the preferred forms and embodiments of the invention have been illustrated and described, it will be apparent to those skilled in the art that changes may be made without deviating from the invention described above.

What is claimed is:

1. Cutting apparatus for severing an electrical conductor, comprising:
(a) a housing (4);
(b) scissors-type cutting means including:
(1) a stationary cutting blade (11) connected with said housing;
(2) a movable cutting blade (9) pivotally connected with said stationary cutting blade for displacement about a given cutting pivot axis (10) between open and closed positions relative to said stationary cutting blade; and
(c) pawl and ratchet means for displacing said movable cutting blade from said open position toward said closed position relative to said stationary cutting blade, said pawl and ratchet means including:
(1) a ratchet tooth arrangement (28) arranged on said movable cutting blade in a generally circular arcuate pattern about said cutting pivot axis;
(2) a transport pawl member (20) connected for reciprocation relative to said housing, said transport pawl member having a first end including pawl teeth (20a) in engagement with said ratchet tooth arrangement, said transport pawl member having a second end; and
(3) drive means (30; 30′) for reciprocating said transport pawl member longitudinally to displace said movable cutting blade from said open position toward said closed position, thereby to sever a conductor inserted between said cutting blades, said drive means including:
(a) a drive shaft (2) connected with said housing for rotation about a longitudinal axis normal to the axis of reciprocation of said transport pawl, said drive shaft having first and second ends; and
(b) reciprocating means for connecting said drive shaft first end with said transport pawl member second end.

2. Cutting apparatus as defined in claim 1, wherein said reciprocating means comprises:
(1) a cylindrical eccentric member (33) connected with said drive shaft first end, said eccentric member having a longitudinal axis that is parallel with, and laterally offset from, said drive shaft longitudinal axis; and
(2) a crank arm (17) having a first end connected with said eccentric member, said crank arm having a second end connected with said transport pawl member second end.

3. Cutting apparatus as defined in claim 2, wherein said crank arm first end is annular and is journalled on said cylindrical eccentric member.

4. Cutting apparatus as defined in claim 1, wherein said reciprocating means (30′) includes:
(1) a cam disk (26) connected with said drive shaft first end, said cam disk having an eccentric circumferential surface relative to said drive shaft longitudinal axis; and
(2) cam follower means (27) driven by said cam disk circumferential surface for reciprocating said transport pawl member.

5. Cutting apparatus as defined in claim 4, and further including a cylindrical cam support cylinder (34) connected collinearly with said drive shaft first end, said cam disk being annular and secured concentrically about said cam support cylinder.

6. Cutting apparatus as defined in claim 5, and further including one-way free-wheel connecting means (40) connected between said drive shaft first end and said cam support cylinder.

7. Cutting apparatus as defined in claim 5, and further including spring means (21′) biasing said cam follower means toward said cam disk circumferential surface.

8. Cutting apparatus as defined in claim 7, wherein said cam follower means comprises:
(1) a sliding block (27) mounted for longitudinal reciprocation relative to said housing, said sliding block having a first end in sliding engagement with said cam disk circumferential surface, said sliding block having a second end;
(2) and means (31, 32) connecting said transport pawl member second end with said sliding block second end for pivotal displacement about a pivot axis parallel with said cutting pivot axis.

9. Cutting apparatus as defined in claim 8, and further including spring means (25) biasing said transport pawl member laterally in a direction to effect engagement between said pawl teeth and said ratchet teeth.

10. Cutting apparatus as defined in claim 1, wherein said drive shaft has a second end having a hexagonal cross-sectional configuration, thereby to permit connection of said drive shaft with the chuck means of an electric hand drill (D).

11. Cutting apparatus as defined in claim 10, and further including a support sleeve (8) connected at one end with said housing, said support sleeve including at its other end resilient clamping means (39) for connecting said cutting apparatus with the electric hand drill.

12. Cutting apparatus as defined in claim 1, wherein said drive means includes a sliding block (18, 27) arranged between said transport pawl member and said drive means, and pivot means (31, 32) connecting said transport pawl member second end with said sliding block for pivotal movement about a pivot axis parallel with said cutting pivot axis.

13. Cutting apparatus as defined in claim 12, and further including spring means (21; 25) biasing said pawl member toward engagement with said ratchet teeth.

14. Cutting apparatus as defined in claim 12, wherein said sliding block is cylindrical; and further including a protective member (19; 35) supporting said sliding block for longitudinal displacement relative to said housing.

15. Cutting apparatus as defined in claim 14, wherein said protective member (19) is annular and is arranged concentrically about said sliding block, said protective member being formed from a fibrous material.

16. Cutting apparatus as defined in claim 1, and further including:
(d) a locking pawl (23, 23′) connected with said stationary cutting blade, said locking pawl being normally arranged in an engaged position in engagement with said ratchet teeth arrangement, thereby to prevent pivotal movement of said movable cutting blade toward said open position relative to said stationary cutting blade.

17. Cutting apparatus as defined in claim 16, and further including:
(e) disengagement pivot means (14) connecting said stationary cutting blade for pivotal movement relative to said housing about an adjustment pivot axis parallel with said cutting pivot axis between engaged and disengaged positions relative to said movable cutting blade; and
(f) disconnect means (7, 22) for pivoting said stationary blade between said engaged and disengaged positions.

18. Cutting apparatus as defined in claim 17, wherein said disconnect means includes:
(1) a lever (7) connected with said housing for pivotal movement about a disconnect pivot axis, and
(2) an eccentric member (22) connected with said lever for engagement with a guide slot (42) contained in said stationary cutting blade.

19. Cutting apparatus as defined in claim 16, and further including locking pawl spring means (24) for biasing said locking pawl member toward engagement with said ratchet teeth.

20. Cutting apparatus as defined in claim 1, wherein said cutting blades include oppositely arranged generally sickle-shaped cutting edges (37, 38).
